(19) United States
(12) Patent Application Publication
(10) Pub. No.: US 2026/0161966 A1
(43) Pub. Date: Jun. 11, 2026

(54) RULE CREATION APPARATUS, RULE CREATION METHOD, AND RULE CREATION PROGRAM

(71) Applicant: NTT, Inc., Tokyo (JP)

(72) Inventors: Nobukazu FUKUDA, Musashino-shi (JP); Chao WU, Musashino-shi (JP); Shingo HORIUCHI, Musashino-shi (JP); Kenichi TAYAMA, Musashino-shi (JP)

(73) Assignee: NTT, Inc., Tokyo (JP)

(21) Appl. No.: 18/694,630

(22) PCT Filed: Sep. 24, 2021
(86) PCT No.: PCT/JP2021/035045

§ 371 Date: Mar. 22, 2024

(51) Int. Cl. G06N 5/025; G06F 16/34; G06F 18/22; G06F 40/30

(52) U.S. Cl. CPC G06N 5/025; G06F 16/345; G06F 18/22; G06F 40/30

(57) ABSTRACT

A rule creation apparatus according to an embodiment includes a first analysis unit, a second analysis unit, a selection unit, and a rule creation unit. The first analysis unit calculates first feature amounts indicating features of event messages acquired from a target system. The second analysis unit calculates a second feature amount indicating a feature of a text including information indicating an intention of a user regarding identification of a failure in the target system. The selection unit selects a possible message corresponding to the intention of the user from the event messages on the basis of a similarity between each of the first feature amounts and the second feature amount. The rule creation unit creates an identification rule for identifying a failure in the target system from the event messages on the basis of the possible message and the text.

### TECHNICAL FIELD

Embodiments of the present invention relate generally to a rule creation apparatus, a rule creation method, and a rule creation program.

### BACKGROUND ART

In service maintenance work, in a case where a failure occurs in a monitored system, it is necessary to identify the occurring failure. Attempts have been proposed to identify a failure on the basis of event messages output by devices or applications in the monitored system.

For example, a method of identifying a cause of a failure by causal inference from system log data has been proposed (see, for example, Non Patent Literature 1). In addition, a method of analyzing a log on the basis of the correlation between log entries (see, for example, Non Patent Literature 2) and a method of estimating a combination of event messages having a high correlation with failure information and learning a rule for identifying a failure have also been proposed (see, for example, Non Patent Literature 3).

### CITATION LIST

### Non Patent Literature

Non Patent Literature 1; S. Kobayashi, K. Otomo, K. Fukuda and H. Esaki, “Mining Causality of Network Events in Log Data,” in IEEE Transactions on Network and Service Management, VOL. 15, NO. 1, pp. 53-67, March 2018, DOI: 10.1109/TNSM.2017.2778096.
Non Patent Literature 2: Marc Platini, Thomas Ropars, Benoit Pelletier, and Noel De Palma, “LogFlow: Simplified Log Analysis for Large Scale Systems,” In International Conference on Distributed Computing and Networking 2021 (ICDCN '21), Jan. 5-8, 2021. Association for Computing Machinery, New York, NY, USA, 116-125.
Non Patent Literature 3: Shunsuke KANAI, et al., “The Learning Process Using Machine Learning for Network Failure,” in IEICE Trans, 2021 Mar. 1.

### SUMMARY OF INVENTION

### Technical Problem

In the case of trying to identify a failure from event messages using a rule, whether the failure can be appropriately identified depends on whether the design of the rule is appropriate. However, the failure to be identified varies depending on the operator and also varies depending on the service to be maintained. Furthermore, the rule for identifying a failure from event messages is vulnerable to a change in the event messages. It is desirable to create a rule reflecting an intention of an operator and to easily correct the created rule according to the situation.

In any of the conventional methods, only the relevance of event messages is analyzed, and it is difficult to create a flexible rule reflecting an intention of an operator. In addition, in order to correct a created rule, a specialized skill is usually required, which increases costs associated with development of correction of a monitoring system.

An object of the present invention is to provide a rule creation apparatus, a rule creation method, and a rule creation program capable of creating a more appropriate rule for identifying a failure from event messages without skill.

### Solution to Problem

In one aspect of the present invention, a rule creation apparatus includes a first analysis unit, a second analysis unit, a selection unit, and a rule creation unit.

The first analysis unit calculates first feature amounts indicating features of event messages acquired from a target system. The second analysis unit calculates a second feature amount indicating a feature of a text including information indicating an intention of a user regarding identification of a failure in the target system. The selection unit selects a possible message corresponding to the intention of the user from the event messages on the basis of a similarity between each of the first feature amounts and the second feature amount. The rule creation unit creates an identification rule for identifying a failure in the target system from the event messages on the basis of the possible message and the text.

### Advantageous Effects of Invention

According to one aspect of the present invention, if a user (operator) prepares a text including information indicating an intention regarding identification of a failure in a target system, a rule for identifying a failure is automatically created on the basis of the similarity between a feature amount of the text and a feature amount of an event message. The user is not required to have a specialized skill to prepare the text, and is only required to prepare a new text in the case of desiring to correct or change the rule. As a result, it is possible to flexibly reflect the intention of the operator, a change in the situation, or the like, and it is possible to create a more appropriate failure identification rule without skill.

According to one aspect of the present invention, it is possible to provide a rule creation apparatus, a rule creation method, and a rule creation program capable of creating a more appropriate rule for identifying a failure from event messages without skill.

### BRIEF DESCRIPTION OF DRAWINGS

FIG. 1 is a schematic diagram illustrating a usage example of a rule creation apparatus according to an embodiment.

FIG. 2 is a block diagram illustrating an example of a hardware configuration of the rule creation apparatus according to the embodiment.

FIG. 3 is a block diagram illustrating an example of a functional configuration of the rule creation apparatus according to the embodiment

FIG. 4 is a chart illustrating an example of an information processing operation of the rule creation apparatus according to the embodiment.

FIG. 5 is a schematic diagram illustrating a usage example of the rule creation apparatus according to the embodiment together with input/output data examples.

### DESCRIPTION OF EMBODIMENTS

Hereinafter, an embodiment according to the present invention will be described with reference to the drawings. Note that, here the same or similar reference signs will be given to components that are the same as or similar to those already described, and redundant description will be basically omitted. For example, in a case where there is a plurality of same or similar components, a common reference sign may be used to escribe the components without distinction of the components, or a branch number may be used in addition to the common reference sign to describe the components with components distinguished.

### EMBODIMENT

### (1) Configuration

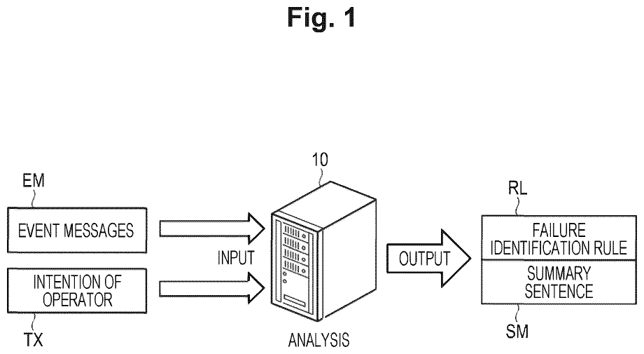

FIG. 1 is a schematic diagram illustrating a usage example of a rule creation apparatus 10 according to an embodiment.

As illustrated in FIG. 1, the rule creation apparatus 10 is a computer that analyzes input data and generates and outputs output data. The rule creation apparatus 10 receives, as input data, event messages EM output from a monitored system and a text TX including information indicating an intention of an operator (hereinafter, such a text will also be simply referred to as an “intention of an operator”). The rule creation apparatus 10 creates and outputs a failure identification rule RL as output data. In addition, the rule creation apparatus 10 can generate a summary sentence SM of the event messages EM and output the summary sentence SM as output data. The rule creation apparatus 10 can exchange data with an external apparatus, for example, via a network connected in a wired or wireless manner. The rule creation apparatus 10 may read input data a built-in or externally-connected storage device. The rule creation apparatus 10 may exchange data with an integrally-provided or extendedly-connected input/output device.

Here, a “monitored system (also simply referred to as a “target system”)” may include a system related to a wide variety of service maintenance work. The monitored system includes, fox example, one of more devices and one or more applications constituting a wide range of networks from a small scale network to a large scale network. The devices or the applications constituting the monitored system generate and output event messages, for example, periodically or when some state change occurs. The event messages may also be referred to as event logs, system logs, application logs, or the like. The event messages may include a message related to a normal operation, a message related to an operation abnormality or an error, a message related to security, and the like.

Furthermore, here, when a “user” is referred to, the “user” is assumed include any user who can input a text including information directly or indirectly indicating an intention to the rule creation apparatus 10. The “user” may also be a single user or may include multiple users. The user includes, for example, an operator, a developer, an administrator, a designer, or the like involved in a monitored system, a monitoring system, or service maintenance work. Here, when an “operator” is simply referred to, the “operator” is not intended to be limited to an operator, and may be appropriately read as a developer, an administrator, a designer, or the like.

### (1-1) Hardware Configuration

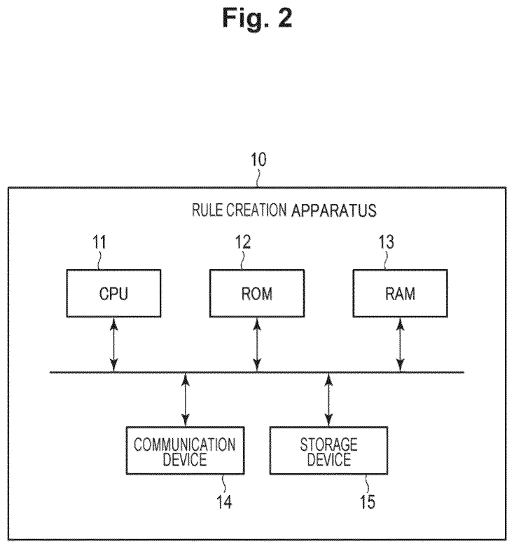

FIG. 2 is a block diagram illustrating an example of a hardware configuration of the rule creation apparatus 10 according to the embodiment. As illustrated in FIG. 2, the rule creation apparatus 10 includes, for example, a central processing unit (CPU) 11, a read only memory (ROM) 12, a random access memory (RAM) 13, a communication device 14, and a storage device 15.

The CPU 11 is an integrated circuit capable of executing various programs. The CPU 11 controls the entire operation of the rule creation apparatus 10. The ROM 12 is a nonvolatile semiconductor memory. The ROM 12 stores a program, control data, and the like for controlling the rule creation apparatus 10. RAM 13 is, for example, a volatile semiconductor memory. The RAM 13 is used as a working area of the CPU 11. The CPU 11 develops the program stored in the ROM 12 into the RAM 13 and interprets and executes the program, thereby implementing various functions to be described later. The communication device 14 is a communication circuit configured to be connectable to a network. The rule creation apparatus 10 can transfer data received via the communication device 14 to the RAM 13 or the storage device 15. In addition, the rule creation apparatus 10 can output output data generated by the CPU 11 to an external device via the communication device 14. The storage device 15 is a nonvolatile storage device. The storage device 15 stores, for example, system software of the rule creation apparatus 10, data acquired via a network, generated or the like. The rule creation apparatus 10 may have another hardware configuration. A display, an input/output interface, a removable storage device, or the like may be connected to the rule creation apparatus 10.

### (1 2) Functional Configuration

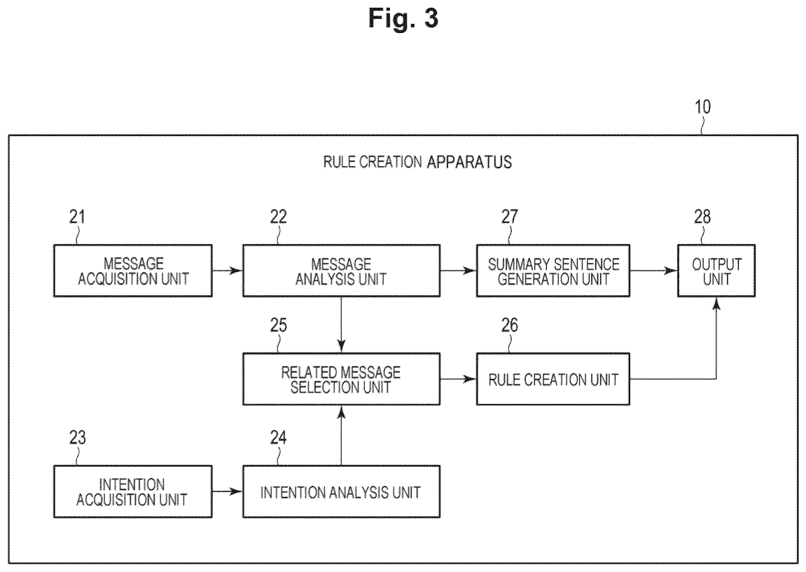

FIG. 3 is a block diagram illustrating an example of a functional configuration of the rule creation apparatus 10 according to the embodiment. As illustrated in FIG. 3, the rule creation apparatus 10 includes, for example, a message acquisition unit 21, message analysis unit 22, an intention acquisition unit 23, an intention analysis unit 24, a related message selection unit 25, a rule creation unit 26, a summary sentence generation unit 27, and an output unit 28.

The message acquisition unit 21 acquires event messages output from a monitored system, performs necessary processing, and passes the event messages the message analysis unit 22. For example, the message acquisition unit 21 is configured to read messages accumulated for a certain period of time from a storage unit (not illustrated) inside or outside the rule creation apparatus 10 in response to an instruction from a user. The message acquisition unit 21 may be configured to read a fixed amount of event messages from the storage unit. The message acquisition unit 21 is an example of a first acquisition unit that acquires a plurality of event messages from a storage unit that stores event messages output from device or application included in a target system and passes the plurality of event messages to a first analysis unit.

The message analysis unit 22 extracts features from the event messages received from the message acquisition unit 21. The message analysis unit 22 can perform feature extraction by various methods. For example, message analysis unit 22 extracts features in units of messages or in units of words from the event messages using a pre-trained language model. The message analysis unit 22 outputs the calculated feature amounts of the messages (feature amounts in units of messages) to the related message selection unit 28. The message analysis unit 22 can also output the calculated feature amounts of the messages of the feature amounts of the words (feature amounts in units of words) to the summary sentence generation unit 27. The message analysis unit 22 is an example of a first analysis unit that calculates first feature amounts indicating features of event messages acquired from a target system.

The intention acquisition unit 23 acquires a text including information indicating an intention of the user regarding identification of a failure in the target system, which is input by the user, performs necessary processing, and passes the text to the intention analysis unit 24. The user can input an intention to the rule creation apparatus 10 in the form of a natural language text including free expression via an input device (not illustrated). The intention acquisition unit 23 acquires, for example , a text input by the user via a keyboard or the like, or reads a text from data stored in advance in the storage device 15. Alternatively, the intention acquisition unit 23 may acquire a text by voice recognition from voice information input by the user via a microphone or the like. The intention acquisition unit 23 is an example of a second acquisition unit that acquires, as a text, a natural language input by a user and passes the text to the second analysis unit.

The intention analysis unit 24 extracts a feature from the text received from the intention acquisition unit 23. The intention analysis unit 24 can also perform feature extraction by various methods. For example, as with the message analysis unit 22, the intention analysis unit 24 extracts a feature from the text using a pre-trained language model. The intention analysis unit 24 outputs a feature amount calculated from the text (which may also be referred to a feature amount of the intention) to the related message selection unit 25. The intention analysis unit 24 is an example of a second analysis unit that calculates a second feature amount indicating a feature of a text including information indicating an intention of a user regarding identification of a failure in a target system.

The related message selection unit 25 extracts an event message related to the intention of the user on the basis of the similarity between each of the feature amounts of the messages received from the message analysis unit 22 and the feature amount of the text received from the intention analysis unit 24, and passes the event message to the rule creation unit 26. A wide variety of methods may be used to determine the similarity. For example, the related message selection unit 28 selects and extracts an event message having the highest similarity between the intention of the user and the feature amount among the acquired event messages. The event message selected and extracted by the related message selection unit 25 is also referred to as a “possible message corresponding to the intention of the user” here. The number of event messages extracted as possible messages may be one or more. The related message selection unit 25 is an example of a selection unit that selects a possible message corresponding to an intention of a user from event messages on the basis of the similarity between each first feature amount and a second feature amount.

The rule creation unit 26 generates a regular expression matching the event message extracted by the related message selection unit 25, and outputs the regular expression to the output unit 28. The regular expression can also be referred to as an identification rule for identifying an event message related to a failure from a large number of event messages. In addition, the identification rule may be used to identify an event related to a failure, and thus can also be referred to as a failure event identification rule. The identification rule may be used to identify a failure or a failure cause, and thus can also be referred to as a failure identification rule. The rule creation unit 26 can generate the regular expression (or create the identification rule) by a wide variety of methods. The rule creation unit 26 generates the regular expression using, example, a log analysis method. The rule creation unit 26 is an example of a rule creation unit that creates an identification rule for identifying a failure in a target system from event messages on the basis of a possible message and a text.

The summary sentence generation unit 27 receives the feature amounts of the messages or the feature amounts of the words from the message analysis unit 22, extracts an important message or an important word on the basis of the feature amounts, and generates a summary sentence on the basis of the extracted important message or word. The summary sentence generation unit 27 outputs the generated summary sentence to the output unit 28. The summary sentence generation unit 27 can generate the summary sentence using a wide variety of methods. For example, the summary sentence generation unit 27 can generate the summary sentence by utilizing data of log abnormality detection. The summary sentence may also be referred to as summary information of the acquired event messages. The summary sentence generation unit 27 is an example of a summary sentence generation unit that generates a summary sentence of event messages on the basis of first feature amounts.

The output unit 28 receives the identification rule created by the rule creation unit 26 and outputs the identification rule to a predetermined output destination. In addition the output unit 28 receives the summary sentence generated by the summary sentence generation unit 27 and outputs the summary sentence to a predetermined output destination. For example, the output unit 28 outputs the identification rule or the summary sentence to an external device via the communication device 14 for presentation to the user. The output unit 28 can also output the identification rule or the summary sentence to the storage device 15 to store the identification rule or the summary sentence in the storage device 15. In one embodiment the output unit 28 outputs the identification rule and the summary sentence to a display or the like to present the identification rule and the summary sentence to the user. The output unit 28 is an example of an output unit that outputs a summary sentence and an identification rule for presentation to a user.

The rule creation apparatus 10 according to the embodiment is used, for example, to narrow down event messages for the purpose of failure cause analysis in a case where a failure occurs in a service in service maintenance work. An enormous number of event messages are output from devices and applications constituting a target system from moment to moment, and the output event messages include many event messages unrelated to the occurring failure. It is not possible to visually check all these event messages. For example, with the above configuration, the rule creation apparatus 10 creates a rule for identifying an event message related to a failure from a large number of event messages on the basis of an intention of a user (operator or the like).

### Operation

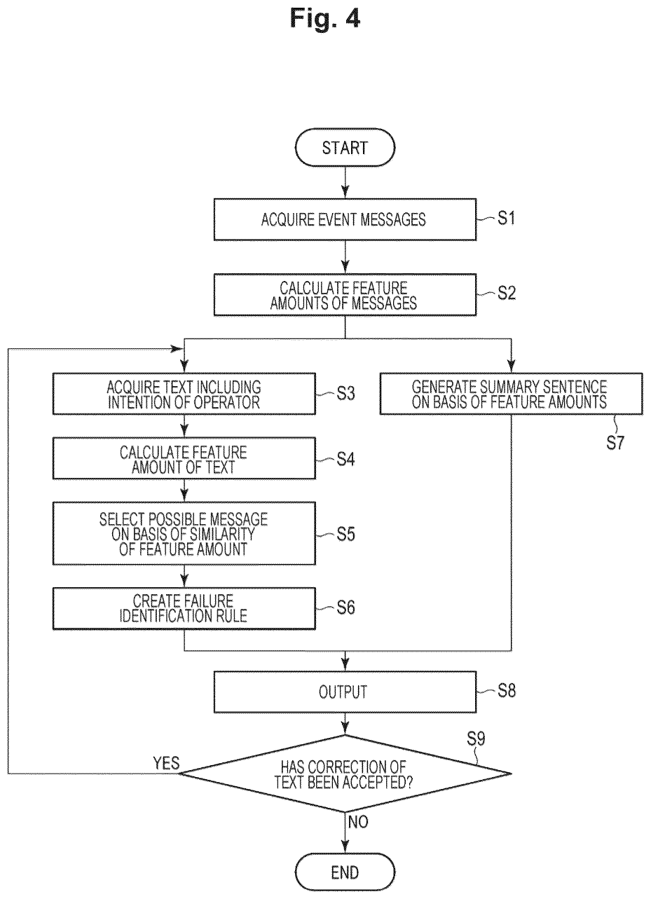

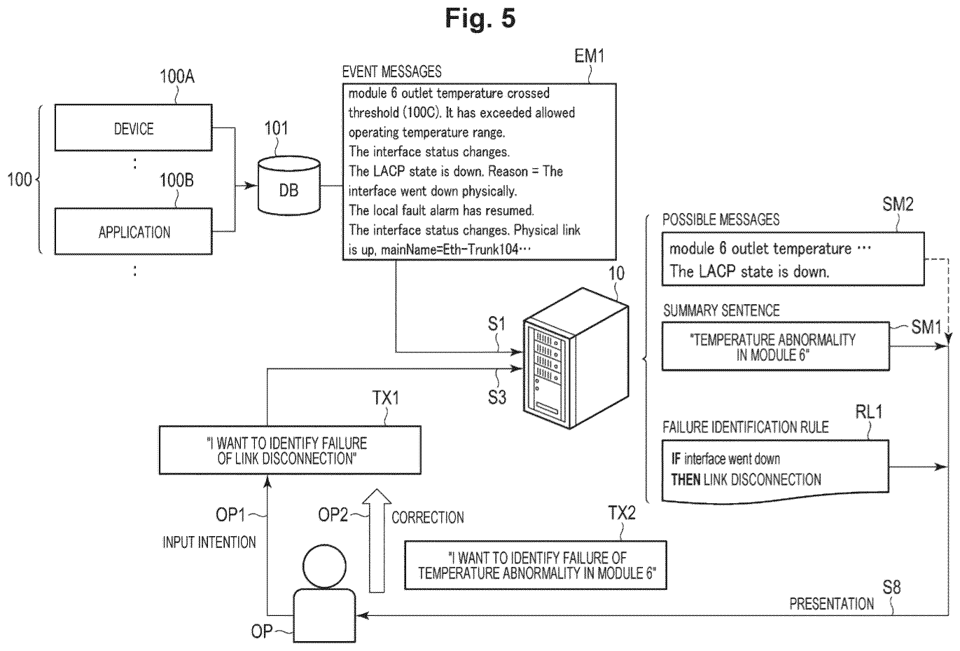

Next, an information processing operation of the rule creation apparatus 10 according to the embodiment will be described with reference to FIGS. 4 and 5. As a premise of the operation, it is assumed that event messages output from devices and applications constituting a target system are aggregated in advance by any device (not illustrated), processed necessary, and stored in a database.

FIG. 4 is a flowchart illustrating an example of the information processing operation of the rule creation apparatus 10 according to the embodiment. The processing of FIG. 4 is started in response to a user inputting an operation start instruction to the rule creation apparatus 10, for example, in a case where a failure occurs in the target system. The operation start instruction may include information indicating an intention of the user.

First, in step S1, the rule creation apparatus 10 acquires event messages for a certain period of time from the above-described database by the message acquisition unit 21. For example, the message acquisition unit 21 reads event messages corresponding to a past certain period of time or a period designated by the user from a time point at which the operation start instruction is accepted from the user. The message acquisition unit 21 passes the acquired event messages to the message analysis unit 22.

FIG. 5 is a schematic diagram illustrating a usage example of the rule creation apparatus 10 according to the embodiment together with input/output data examples. Event messages transmitted from a device group 100A and an application group 100B included in a target system 100 are stored in advance in a database 101.

In FIG. 5, the rule creation apparatus 10 acquires event messages EM1 from the database 101 by the message acquisition unit 21 (S1). As illustrated in FIG. 5, the acquired event messages EM1 include a plurality of event messages as shown below, which are merely examples. Each of the plurality of messages corresponds to an event occurring in any device or application.
“module 6 outlet temperature crossed threshold (100C).”
“It has exceeded wed stating temperature range.”
“The interface status changes.”
“The LACP state is down.”
“Reason=The interface down physically.”
“The local fault alarm has resumed.”
“The interface status changes.”
“Physical link is up, mainName=Eth−Trunk104 . . . ”

Next, in step S2 of FIG. 4, the rule creation apparatus 10 calculates feature amounts of the messages from the acquired event messages by the message analysis unit 22. The message analysis unit 22 can perform feature extraction, for example, by transferring a language model trained with a general language corpus to a domain of an event message. A known technique may be used as a transfer technique. As a language model, for example, a language model proposed by Devlin et al. can be used (see Devlin, J. et al. “BERT; Pre-training of Deep Bidirectional Transformers for Language Understanding.” NAACL-HLT (2019)). For example, when the language model BERT of Devlin et al. is used, a 768-dimensional feature amount (feature vector) is obtained. The message analysis unit 22 can calculate such feature amounts in units of messages or in units of words. The message analysis unit 22 passes the calculated feature amounts of the messages to the related message selection unit 25. The message analysis unit 22 also passes the calculated feature amounts of the messages or the feature amounts of the words to the summary sentence generation unit 27.

In step S3 of FIG. 4, the rule creation apparatus 10 acquires, by the intention acquisition unit 23, a text including information indicating an intention of the operator (user), and passes the acquired text to the intention analysis unit 24. The intention acquisition unit 23 acquires the text as a text described in a natural language input by the user via, for example, a keyboard or the like.

In the example of FIG. 5, a user (operator) OP inputs a text TX1 “I want to identify failure of link disconnection” as a text including information indicating an intention (OP1). As in this example, the user can input an intention in free expression and in free language. The rule creation apparatus 10 acquires the input text TX1 by the intention acquisition unit 23 (S3). The text TX1 input by the user may be temporarily stored in the storage device 15 of the rule creation apparatus 10 or an external storage device and then read by the intention acquisition unit 23.

Next, in step S4 of FIG. 4, the rule creation apparatus 10 calculates a feature amount of the text including the information indicating the intention of the user by the intention analysis unit 24. The intention analysis unit 24 can be implemented by a mechanism similar to that of the message analysis unit 22 as described above. As an example, the intention analysis unit 24 obtains a 768-dimensional feature amount using the language model BERT proposed by Devlin et al. The intention analysis unit 24 passes the calculated feature amount of the text to the related message selection unit 28.

In step S5 of FIG. 4, the rule creation apparatus 10 selects, by the related message selection unit 25, a possible message corresponding to the intention of the user from the event messages acquired by the message acquisition unit 21 on the basis of the similarity between the feature amount of each message received from the message analysis unit 22 and the feature amount of the text received from the intention analysis unit 24. For example, the related message selection unit 25 calculates the cosine similarity between feature amounts (feature vectors), and selects an event message having the highest similarity to the feature amount of the text as a possible message. Here, as an example, it is assumed that “module 6 outlet temperature crossed threshold (100C).” and “The LACP state is down.” are selected as possible messages among the event messages EM1 illustrated in FIG. 5. The related message selection unit 25 passes the selected possible messages to the rule creation unit 26. The related message selection unit 25 may select more event messages as possible messages, or may select one event message as a possible message.

In step S6 of FIG. 4, the rule creation apparatus 10 creates a failure identification rule for identifying a failure on the basis of the selected possible messages by the rule creation unit 26. The failure identification rule can also be referred to as a regular expression or a template for detecting an event message related to a failure. The rule creation unit 26 can use, for example, a log analysis method proposed by Huang et al. (see Huang, Shaohan et al. “Paddy: An Event Log Parsing Approach using Dynamic Dictionary.”, NOMS 2020-2020 IEEE/IFIP Network Operations and Management Symposium (2020)) or a rule creation method proposed by Kanai et al. (see Non Patent Literature 3). When these methods are used, for example, a failure identification rule in the format of “IF . . . , THEN . . . ” is created. The rule creation unit 26 passes the created failure identification rule to the output unit 28.

In the example of FIG. 5, a failure identification rule RL1 “IF interface went down, THEN link disconnection” is created on the basis of the possible messages “module 6 outlet temperature crossed threshold (100C).” and “The LACP state is down.” and the text TX1 “I want to identify failure of link disconnection”. In the failure identification rule RL1, “interface went down” after “IF” defines an event, and “link disconnection” after “THEN” defines a failure (including a cause of the failure, a location of the failure, or the like). Such a failure identification rule may be very useful for identifying a failure from a large number of event messages if the rule is suitable for a target service or a target system, but may be useless if the rule is not suitable. However, in order to correct the failure identification rule according to the situation, a specialized rule design skill is required.

Even in a case where the intention input by the user is not suitable for identifying a failure in the target service or the target system, the rule creation apparatus 10 according to the embodiment enables optimization of the identification rule without highly specialized skill by an interactive framework that repeats presentation of the created rule to the user and acceptance of correction of the intention from the user. The rule creation apparatus 10 further presents a summary sentence of the event messages to the user together with the created rule, and thus can assist the user to grasp the situation and determine to correct the intention, and can promote the optimization of the rule.

In step S7 of FIG. 4, the rule creation apparatus 10 generates a summary sentence of the event messages by the summary sentence generation unit 27 on the basis of the feature amounts of the messages or the words received from the message analysis unit 22. For example, the summary sentence generation unit 27 selects an important word on the basis of the feature amounts in units of words extracted from the event messages, and generates a summary sentence using the selected word. More specifically, the summary sentence generation unit 27 can generate a summary sentence, for example, by using a method of generating a sentence using multitasking learning proposed by Nishino et al. (see Nishino, Toru et al. “Keeping Consistency of Sentence Generation and Document Classification with Multi-Task Learning.” EMNLP/IJCNLP (2019)), a log abnormality detection model proposed by Meng et al. (see Meng, Weibin et al. “LogAnomaly: Unsupervised Detection of Sequential and Quantitative Anomalies in Unstructured Logs.” IJCAI (2019)), or a word selection method by a decoder of a summary model proposed by Liu et al. (see Liu, Yang and Mirella Lapata. “Text Summarization with Pretrained Encoders.” EMNLP/IJCNLP (2019) ). The summary sentence generation unit 27 passes the generated summary sentence to the output unit 28. In the example illustrated in FIG. 5, “temperature abnormality in module 6” is generated as a summary sentence SM1.

Next, in step S8 of FIG. 4, the rule creation apparatus 10 outputs the failure identification rule and the summary sentence for presentation to the user by the output unit 28. The output unit 28 outputs, for example, the failure identification rule and the summary sentence as character information to an external display device such as a display, and causes the display device to display the failure identification rule and the summary sentence to the user. The failure identification rule and the summary sentence may be output as voice information by a speaker or the like. The failure identification rule and the summary sentence may be output together or may be output separately. In addition, the output unit 28 may output one or both of the failure identification rule and the summary sentence to the storage device 15 to store the one or both of the failure identification rule and the summary sentence.

In the example of FIG. 5, the failure identification rule RL1 “IF interface went down, THEN link disconnection” and the summary sentence SM1 “temperature normality in module 6” are output from the rule creation apparatus 10 and presented the user OP (S8). As illustrated in FIG. 5, in addition to the summary sentence SM1 or instead of the summary sentence SM1, a possible message SM2 selected by the related message selection unit 25 may be presented to the user OP. As illustrated, the possible message SM2 includes “module 6 outlet temperature . . . ” and “The LACP state is down,” among the event messages EM1.

The user OP can check the presented contents and examine necessity to correct the intention input in advance. Here, the user OP desires to correct the intention, and inputs a new text TX2 “I want to identify failure of temperature abnormality in module 6”, which reflects the corrected intention (OP2).

In step S9 of FIG. 4, the rule creation apparatus 10 determines whether correction of the text has been accepted from the user by, for example, the intention acquisition unit 23. For example, if an operation of the user is not accepted within a certain period of time after the failure identification rule is output, the rule creation apparatus 10 determines that correction of the text has not been accepted (No in step S9) and ends the processing. On the other hand, in a case where correction of the text (input of a new text) is accepted from the user within the certain period of time after the failure identification rule is output (YES in step S9), the rule creation apparatus 10 proceeds to step S3.

In step S3 again, the rule creation apparatus 10 acquires the corrected text by the intention acquisition unit 23, and similarly executes the processing in subsequent steps S4 to S6. Here, as an example, it is assumed that the event messages are not acquired again before and after the correction of the intention, and the processing is repeated by use of the same feature amounts of the event messages. Therefore, in step S5, the related message selection unit 25 reselects a possible message on the basis of the similarity between each of the feature amounts of the event messages calculated before the correction of the intention and a feature amount newly calculated from the corrected text. When a new failure identification rule is created in step S6, the rule creation apparatus 10 outputs the new failure identification rule and presents the new failure identification rule to the user in step S8. In this case, the rule creation apparatus 10 may output the new failure identification rule alone or may output the output summary sentence together again. Thereafter, in step S9, the rule creation apparatus 10 determines again whether correction of the text has been accepted. Note that, in the rule creation apparatus 10, a limit may be set to the number of times (or period of time of the like) of accepting correction of the text, or correction may be accepted without limitation.

### Effects

As described above in detail, the rule creation apparatus 10 according to the embodiment receives an intention of a user (for example, “I want to identify failure of link disconnection.”) as a natural language, and repeats work of creating a failure identification rule for identifying a failure from event messages, thereby enabling design of a rule that can identify various failures in a target system without skill. In addition, the rule creation apparatus 10 presents summary information of the event messages to the user together with the created rule so that the user can easily grasp the situation of the target system, and assists the user to update the intention for optimizing the failure identification rule.

In a case where a failure occurs in service maintenance work, it is necessary to quickly identify a failure of a device or an application constituting the monitored system. In order to identify a failure, event messages generated in the monitored system are monitored, but there are a large number of event messages unrelated to the failure, and thus an identification rule for narrowing down the event messages to an event message related to the failure is useful. However, since the identification rule is unique to the service and requires specialized knowledge for design and correction, it takes a lot of costs to create a rule in accordance with an intention of an operator or the like for each service.

According to the rule creation apparatus 10 according to the embodiment, an operator or the like can create a target rule without skill while adjusting input of an intention by an interactive framework using a natural language. Therefore, according to the embodiment, it is possible to flexibly cope with system renewal, and it is possible to reduce development/correction costs of a monitoring system.

### Other Embodiments

Note that the present invention is not limited to the above embodiment.

For example, the flowchart illustrated in FIG. 4 is merely an example and the processing order may be changed within a possible range or other processing may be added as long as a result similar to that of the embodiment can be obtained. For example, steps S3 to S6 related to the creation of a failure identification rule and step S7 related to the generation of a summary sentence illustrated in FIG. 4 may be executed simultaneously in parallel or may be executed separately. In addition, steps S1 to S2 and steps S3 to S4 may be executed in the reverse order or may be executed simultaneously in parallel. The generation of a summary sentence in step S7 may be omitted. In a case where step S7 is omitted, only the created failure identification rule may be presented to the user, and correction of the intention may be accepted.

Alternatively, a selected possible message may be presented to the user together with the created failure identification rule, and correction of the intention may be accepted.

In the present specification, the rule creation apparatus 10 may be referred to as a “server” or a “processing server”. The CPU 11 may be referred to as a “processor”. Each of the ROM 12, the RAM 13, and the storage device 15 may be referred to as a “storage circuit”. In addition, the units 21 to 28 included in the rule creation apparatus 10 may be dispersedly arranged in a plurality of devices, and these devices may cooperate with each other to perform processing.

Note that, as exemplified above, the rule creation apparatus 10 according to the embodiment can be applied without limitation on languages of the event messages and the text indicating an intention. If the event messages and the text indicating an intention are in the same language, it is expected that the accuracy will be improved. In a case where the event messages and the text indicating an intention are in different languages, for example, a cross-lingual language model (XLM) or the like may be used (see, for example, https://arxiv.org/abs/1901.07291, Jan. 22, 2019).

The hardware configuration of the rule creation apparatus 10 described in the embodiment is merely an example. The CPU 11 included in the rule creation apparatus 10 may be another circuit. For example, in the rule creation apparatus 10, a micro processing unit (MPU), a graphics processing unit (GPU), an application specific integrated circuit (ASIC), a field-programmable gate array (FPGA), or the like may be used instead of the CPU 11. The processing described in the embodiment may be implemented by dedicated hardware. In the processing of the rule creation 10, processing executed by software and processing executed by hardware may be mixed, or only one of them may be used.

The method described above can be stored, as a program (software means) that can be executed by a computing machine (computer), in a recording medium (storage medium) such as a magnetic disk (floppy (registered trademark) disk, hard disk, or the like), an optical disk (CD-ROM, DVD, MO, or the like), or a semiconductor memory (ROM, RAM flash memory, or the like), and can also be distributed by being transmitted through a communication medium. Note that the program stored on the medium side also includes a setting program for configuring, in the computing machine, the software means (including not only an execution program but also table and a data structure) to be executed by the computing machine. The computing machine that implements the above device executes the above-described processing by reading the program recorded in the recording medium, constructing the software means by the setting program as needed, and controlling the operation by the software means . Note that the recording medium in the present specification is not limited to a recording medium for distribution, and includes a storage medium such as a magnetic disk or a semiconductor memory provided in a device inside the computing machine or connected via a network.

Note that the present invention is not limited to the above embodiment, and various modifications can be made at the implementation stage without departing from the gist of the invention. In addition, the embodiments may be appropriately combined and implemented, and in this case, combined effects can be obtained. Furthermore, the above embodiment includes various inventions, and various inventions can be extracted by combinations selected from a plurality of disclosed components. For example, in a case where the problems can be solved and the advantageous effects can be obtained even if some components are deleted from all the components described in the embodiment, a configuration from which the components are deleted can be extracted as an invention.

### REFERENCE SIGNS LIST

11 CPU
12 ROM
13 RAM
14 Communication device
15 Storage device
21 Message acquisition unit
22 Message analysis unit
23 Intention acquisition unit
24 Intention analysis unit
25 Related message selection unit
26 Rule creation unit
27 Summary sentence generation unit
28 Output unit

1. A rule creation apparatus comprising:
a first analysis unit that calculates first feature amounts indicating features of event messages acquired from a target system;
a second analysis unit that calculates a second feature amount indicating a feature of a text including information indicating an intention of a user regarding identification of a failure in the target system;
a selection unit that selects a possible message corresponding to the intention of the user from the event messages on a basis of a similarity between each of the first feature amounts and the second feature amount; and
a rule creation unit that creates an identification rule for identifying a failure in the target system from the event messages on a basis of the possible message and the text.

2. The rule creation apparatus according to claim 1, further comprising:
a summary sentence generation unit that generates a summary sentence of the event messages on a basis of the first feature amounts; and
an output unit that outputs the summary sentence and the identification rule for presentation to the user.

3. The rule creation apparatus according to claim 1, wherein
in a case where the text including the information indicating the intention of the user is corrected,
the second analysis unit calculates a third feature amount indicating a feature of the corrected text,
the selection unit further reselects the possible message from the event messages on a basis of a similarity between each of the first feature amounts and the third feature amount, and
the rule creation unit further creates a new identification rule on a basis of the reselected possible message and the corrected text, and updates the identification rule created before the correction of the text with the new identification rule.

4. The rule creation apparatus according to claim 1, further comprising:
a first acquisition unit that acquires a plurality of event messages from a storage unit that stores event messages output from a device or an application included in the target system, and passes the plurality of event messages to the first analysis unit; and
a second acquisition unit that acquires, as the text, a natural language input by the user and passes the text to the second analysis unit.

5. The rule creation apparatus according to claim 1, wherein
the selection unit selects the possible message by calculating a cosine similarity between each of the first feature amounts and the second feature amount and extracting an event message having a first feature amount having a highest similarity to the second feature amount.

6. A rule creation method comprising:
calculating first feature amounts indicating features of event messages acquired from a target system;
calculating a second feature amount indicating a feature of a text including information indicating an intention of a user regarding identification of a failure in the target system;
selecting a possible message corresponding to the intention of the user from the event messages on a basis of a similarity between each of the first feature amounts and the second feature amount; and
creating an identification rule for identifying a failure in the target system from the event messages on a basis of the possible message and the text.

7. A non-transitory computer readable storage medium storing a computer program which is executed by a rule creation apparatus to provide the steps of:
calculating first feature amounts indicating features of event messages acquired from a target system;
calculating a second feature amount indicating a feature of a text including information indicating an intention of a user regarding identification of a failure in the target system;
selecting a possible message corresponding to the intention of the user from the event messages on a basis of a similarity between each of the first feature amounts and the second feature amount; and
creating an identification rule for identifying a failure in the target system from the event messages on a basis of the possible message and the text.
